(19) United States
(12) Patent Application Publication
(10) Pub. No.: US 2016/0220331 A1
(43) Pub. Date: Aug. 4, 2016

(54) ORTHODONTIC BITE CORRECTOR

(71) Applicant: Michael Stuart Johnston, Simpsonville, SC (US)

(72) Inventor: Michael Stuart Johnston, Simpsonville, SC (US)

(21) Appl. No.: 14/611,497

(22) Filed: Feb. 2, 2015

(51) Int. Cl. A61C 7/36; A61C 7/18; A61C 7/20

(52) U.S. Cl. CPC A61C 7/36; A61C 7/20; A61C 7/18

(57) ABSTRACT

A method and apparatus for correcting Class II and Class III malocclusions is disclosed. More specifically, the described orthodontic bite corrector may be installed on multiple points of attachment, including an archwire or an orthodontic band. Preferably, the bite corrector is comprised of a coil spring wrapped around a push rod, the coil spring and a portion of the push rod being contained within a spring housing. A mechanism of attachment is also provided on both the rod and the housing. The mechanism of action is such that the majority of corrective forces are the result of spring expansion, rather than spring compression.

### BACKGROUND OF THE INVENTION

Malocclusions between the upper and lower dentition of a patient generally fall within three classes, which may be skeletal in nature, dental in nature, or a combination of both. Class I malocclusions, otherwise known as neutroclusion, are those in which there is a normal antero-posterior relationship between the maxillary arch and mandibular arch, and there is a Class I molar as defined by Dr. Edward H. Angle, but misalignment of teeth exists. This malocclusion is commonly corrected with braces applied to the teeth for gradual realignment. Class II malocclusions, otherwise known as distoclusion, are those in which the mandibular arch or lower jaw is posteriorly positioned in relationship to the maxillary arch, and the mandibular first molar is distally positioned in relationship with the maxillary first molar. In this type of malocclusion an “overbite” (in layman's terms) condition exists and may be corrected by either moving the lower jaw forward orthopedically or surgically, moving the mandibular dentition forward, moving the upper teeth posteriorly, or a combination of these to obtain a proper bite. Corrective appliances are utilized to produce these desired outcomes. Class III malocclusions, otherwise known as mesioclusion, occur when the mandibular arch or lower jaw is positioned too far anteriorly with respect to the upper arch and the mandibular first molar is mesially positioned in relationship with the maxillary first molar. This condition, often referred to as an underbite, may be corrected with the use of braces, rubber bands, protraction facemask therapy, and/or, in some cases, through surgery.

The present invention generally relates to appliances for treating Class II or Class III malocclusions or, overbite and underbite conditions, respectively. In the past, rubber bands, springs, or Herbst-type pistons extending between upper and lower sets of brackets have been used to move the dentition into alignment. Over time, this corrective movement will permanently realign the upper and lower teeth of the patient through dental movement and/or proper bone growth. External headgear attached to the braces of the patient has been used for similar purposes. One main disadvantage with rubber bands and external headgear is that they each require cooperation on the part of the patient. In other words, the patient is required to regularly maintain the rubber bands or headgear in place. Patients may choose not to apply the corrective appliances because they are unsightly or uncomfortable or may forget to apply them. In either case, the lack of diligence in using the corrective appliances reduces the effectiveness of the treatment.

Class III malocclusions can be the most challenging to correct. It would therefore be advantageous to provide a method and apparatus for underbite correction that negates the need for surgery and eliminates the issue of patient non-compliance. Most of the current corrective orthodontic devices are designed for Class I and Class II malocclusions. There are very few dental appliances currently available for specifically correcting Class III malocclusions. Most devices used to correct Class III malocclusions are actually designed for Class II and are simply installed in a modified manner for correction of an underbite.

U.S. Pat. No. 6,358,046 describes an orthodontic appliance for correction of Class II or III malocclusions that attaches to the maxillary arch at the first molar and to the mandibular arch on the archwire in the cuspid or bicuspid area, and applies a low continuous force through the use of two plunger piston type devices with compression springs disposed in the piston cylinders.

U.S. Patent Publication No. 2012/0070797 describes an orthodontic correction system for Class II and Class III malocclusions, having a variable length alignment assembly useful in providing corrective orthodontic forces to a patient's dentition and/or jaw via hinges that attach the alignment assembly between maxillary and mandibular archwires.

U.S. Patent Publication No. 2014/0242534 describes a mandibular attachment structure having a force member connecting the mandibular and maxillary portions of the assembly. The structure includes bands dimensioned to encircle corresponding lower molars on opposite sides of the tongue, and threadless couplers each of which is removably or releasably affixed to a buccal side of a corresponding band. The pressing connection is maintained by cooperating a hook at the end of the force member and a hook at the end of a threadless coupler.

Heretofore, orthodontic devices for the correction of Class II and Class III malocclusions are cumbersome and tedious to install, have exposed components that are uncomfortable for the wearer, and include elements prone to breakage. Additionally, the prior art devices are designed to be installed exclusively to an archwire, or exclusively to a molar band. It would be advantageous to provide a bite correction device that is simple, reliable, and comfortable for the patient. It would also be advantageous to provide a bite correction device that is versatile, yet easy to install.

### BRIEF SUMMARY OF THE INVENTION

In view of the above problems and limitations of the prior art, one purpose of the present invention is to provide a method and apparatus for correcting Class II and Class III malocclusions. More specifically, the present invention relates to an orthodontic bite corrector that may be installed on either an archwire or an orthodontic band. Preferably, the bite corrector is comprised of a coil spring wrapped around a push rod, the coil spring and a portion of the push rod being contained within a spring housing. A mechanism of attachment is also provided on both the rod and the housing.

Another aspect of the present invention is to provide an apparatus that may be installed in a manner to provide movement of the teeth, movement of the jaw, or both. To effect tooth movement, the bite corrector may be attached to a desired position along the length of a maxillary and mandibular archwire. To effect tooth plus jaw movement, the bite corrector may be attached to an orthodontic band secured around upper and lower teeth.

Typically, known devices used to correct Class II malocclusions attach at the upper first molar and distal to or behind the lower canine. However, in correction of Class II malocclusions, the present invention is capable of attaching distal to the upper canine and at the lower first molar, an arrangement opposite that of typical devices. In correction of Class III malocclusions, known devices typically attach at the lower first molar and distal to the upper canine, whereas in the correction of Class III malocclusions, the present invention is capable of attaching at the upper first molar and distal to the lower canine, an arrangement opposite that of typical devices.

Yet another aspect of the present invention is to provide a spring activated bite correction device wherein the majority of corrective forces are the result of spring expansion, rather than spring compression. In other words, the present invention will bring the ends of the appliance closer together, whereas, prior art inventions work to move the ends of the appliance farther apart. Once the bite corrector has been installed in the desired manner and position, the natural opening and closing of the mouth facilitates activation of the spring and correction of the bite. As the mouth opens, the rod is pulled outward from the housing, thus compressing the spring. As the mouth closes, the spring rebounds and expands, thus pulling the rod inward into the housing. This spring expansion pulls the rod further inside the housing, thus, in correction of Class III malocclusions, moving or pulling the mandibular teeth and lower jaw back, while simultaneously moving or pushing the maxillary teeth and upper jaw forward. This mechanism of action works contrary to current spring activated orthodontic devices in which the spring is pulled to expansion during mouth opening and compressed upon mouth closure; thus supplying the corrective forces mainly during spring compression. This latter mechanism results in strain on the spring and frequent device failure or breakage. The design of the present invention preserves the integrity of the spring, resulting in a more reliable and effective device.

### DESCRIPTION OF THE DRAWINGS

These and other features, aspects, and advantages of the present invention will become better understood with regard to the following description, appended claims, and accompanying drawings where:

FIG. 1 illustrates a side view of one embodiment of an orthodontic bite corrector;

FIG. 2 illustrates a cross-sectional side view of one embodiment of an orthodontic bite corrector;

FIG. 3a illustrates a top view of one embodiment of an orthodontic bite corrector showing a mandibular archwire attachment placed distal to the mandibular canine, and a maxillary archwire attachment mechanism free for attachment to a maxillary archwire;

FIG. 3b shows an inset from FIG. 3a, illustrating a top view of one embodiment of a self-ligating archwire attachment mechanism;

FIG. 4 illustrates a cross-sectional side view of one embodiment of a self-ligating archwire attachment mechanism for an orthodontic bite corrector in an open position;

FIG. 5 illustrates a cross-sectional side view of one embodiment of a self-ligating archwire attachment mechanism for an orthodontic bite corrector in a closed position;

FIG. 6 illustrates a side view of one embodiment of an orthodontic bite corrector attached to upper and lower orthodontic bands;

FIG. 7 illustrates an exploded side view of one embodiment of an orthodontic band attachment mechanism;

FIG. 8 illustrates a plan view of one embodiment of an orthodontic bite corrector attached to upper and lower first molar bands.

### DETAILED DESCRIPTION OF THE INVENTION

The present invention provides a method and apparatus for correcting Class II and Class III malocclusions, dental asymmetries, and/or dental related skeletal abnormalities. This appliance may be installed independently or fitted to a patient's currently installed orthodontic appliance such as brackets, archwires, dental bands, and the like. Preferably, the present invention may be used to correct a Class III malocclusion, otherwise known as an underbite. In an underbite, the mandible (lower jaw) has outgrown the maxilla (upper jaw and palate), resulting in the lower jaw protruding beyond the upper jaw such that the upper and lower teeth do not align with one another. To correct this misalignment, the therapeutic goal is to move the maxillary teeth forward and the mandibular teeth back, such that they are in correct alignment with one another. An additional therapeutic goal is to promote growth of the upper jaw, if possible. Although growth of the lower jaw cannot be stopped or prevented, in some patients, especially children and younger patients, it may be possible to facilitate forward movement of the maxilla.

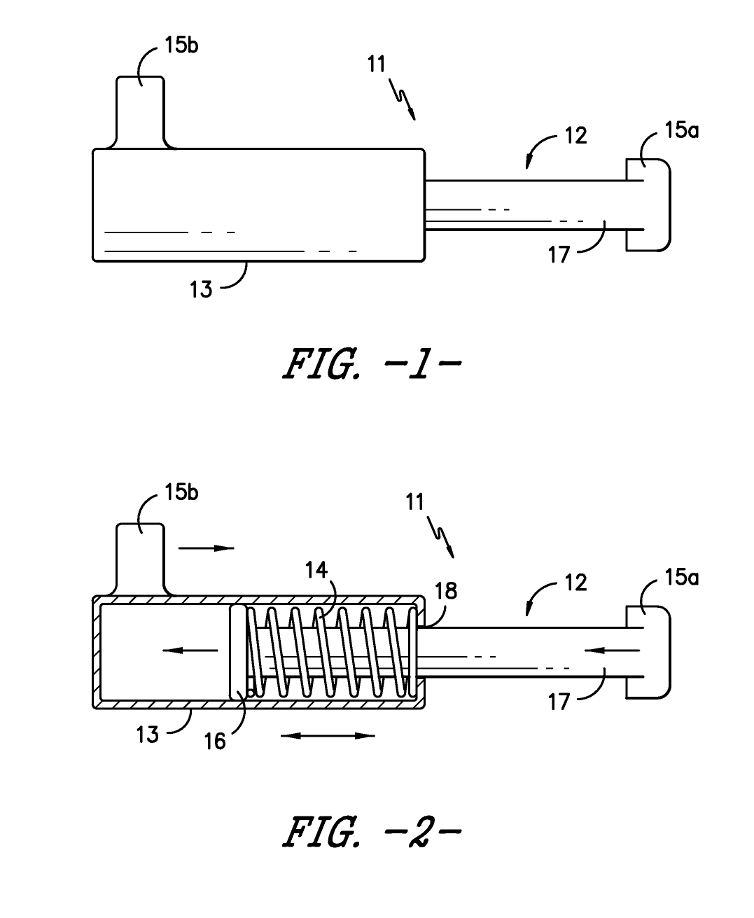

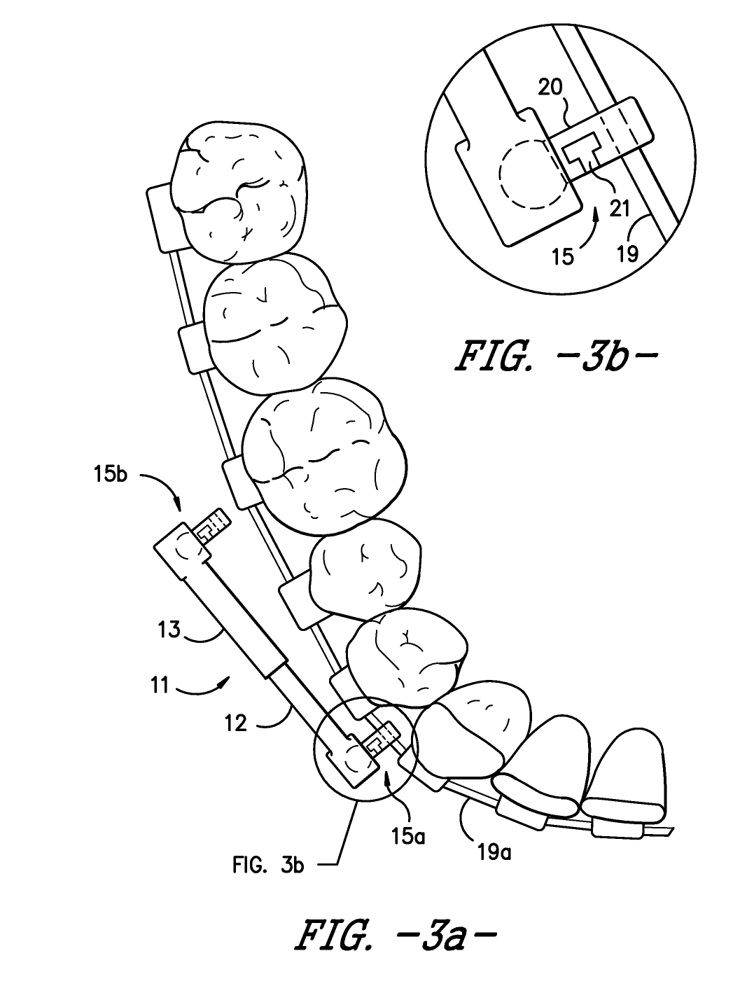

In a preferred embodiment, the orthodontic bite corrector 11 comprises a push rod 12, a spring housing 13, a coil spring 14, and a mechanism 15 of installing or attaching the appliance to the teeth or preexisting braces. The coil spring 14 may be wrapped around the push rod 12, whereby the spring 14 and the portion of the push rod 12 contacting the spring 14 are enclosed in the housing 13. FIGS. 1 and 2 illustrate a side view of this embodiment. The exterior of the bite corrector apparatus 11 is preferably smooth to provide the most comfort for the patient by preventing areas of the corrector 11 from rubbing against or catching on portions of the inner cheek, lips, and other areas of the mouth. Preferably, the corrector 11 is constructed from stainless steel and the spring 14 from nickel titanium; although, other materials may be used, such as titanium, cobalt chromium, and any other similar suitable material. Cobalt chromium is especially suitable for people who are allergic or have sensitivity to nickel.

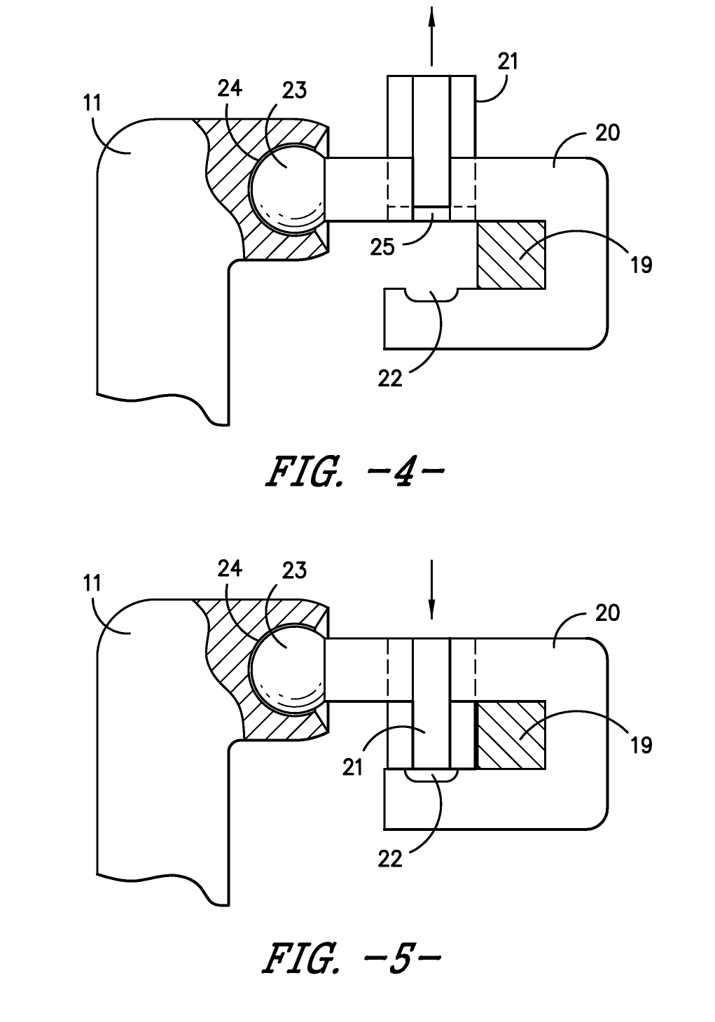

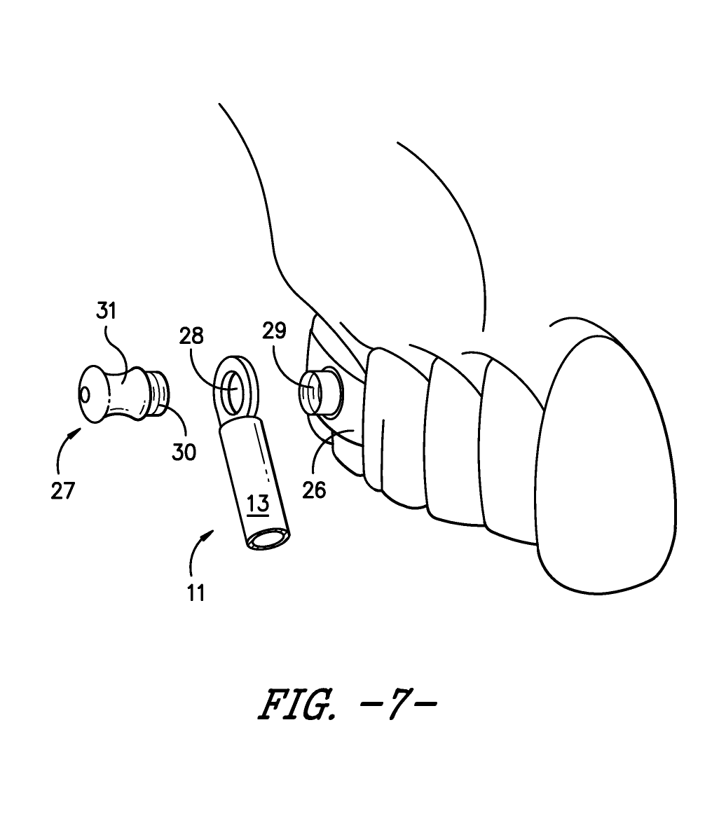

Depending on the type of correction needed and the skeletal development of the patient, the corrector 11 may be installed in a manner to provide either a more dental effect (movement of the teeth) or a more skeletal effect (movement of the jaw). To provide more dental movement, the bite corrector 11 may have a spring 14 that expresses lower forces consistent with tooth movement and may be attached to a desired position along the length of a maxillary and mandibular archwire 19, as shown in FIG. 3a. To provide more skeletal effect, or tooth plus jaw movement, the bite corrector 11 may have a spring 14 that expresses greater forces consistent with skeletal movement of the maxilla and may be attached to a band 26 secured around the upper and lower teeth—preferably the upper and lower molars, or upper molars and lower bicuspids, or premolars, as shown in FIGS. 6-8.

FIG. 2 illustrates a preferred arrangement of the bite corrector 11 components. This embodiment is described in terms of correcting a Class III malocclusion, and descriptive terms used herein, such as mesial, distal, mandibular, and maxillary for example, are not intended to limit the device to only this preferred arrangement. It is to be understood that the device may be arranged as needed for the desired correction. The push rod 12 is preferably comprised of a head 16, a shank 17, and a mesial attachment mechanism 15a for attaching the rod 12 to a mandibular archwire 19a or lower band 26. A coil spring 14 may be wrapped around the shank 17 of the push rod 12, adjacent the head 16 of the rod 12. The spring 14 is preferably made of nickel titanium, and the strength or force of the spring 14 may vary depending on the amount and type of correction desired. For example, a spring force in the range of 100-300 grams is preferred if the corrector 11 is attached to an archwire, whereas a force of 400 grams or greater is preferred if the corrector 11 is attached to an orthodontic band 26. The rod head 16 and the coil spring 14 may be fully contained within the spring housing 13. One end of the housing 13 includes a distal attachment mechanism 15b, preferably protruding upward, for attachment to a maxillary archwire 19b or an upper band 26; the other end of the housing 13—opposite the attachment mechanism 15b—includes an opening 18 from which the push rod 12 may extend, as seen in FIG. 2. The positioning of the coil spring 14 between the head 16 of the push rod 12 and the inner wall of the spring housing 13, as shown, maintains position of the spring 14 and helps to control the compression and expansion of the spring 14. The length of the push rod 12 and the length of the spring housing 13 may vary depending on the size of the patient's mouth, the size of the mouth opening, and the severity of the malocclusion. For example, a child would most likely have a spring housing 13 and push rod 12 of shorter length, versus a grown adult who would more likely require a spring housing 13 and push rod 12 of longer length. Additionally, some people have the ability of opening their mouths wider than others, and these people would likely require an appliance with a longer length to prevent restriction of mouth movement.

FIGS. 3a-5 illustrate an exemplary arrangement of the present invention for attachment to a maxillary archwire 19b and mandibular archwire 19a (also referred to herein as upper and lower archwire, respectively). The preferred size and strength of the archwire is 0.019″×0.025″ stainless steel wire, although other wire may be used. In this particular embodiment, the attachment mechanism 15b extending distally from the housing component 13 is attached to an upper archwire 19b, preferably behind a bracket attached to the maxillary first molar. The attachment mechanism 15 extending mesially from the push rod 12 is attached to a lower archwire 19a, preferably behind the lower canine bracket (see FIG. 3a). FIG. 3a illustrates a top view of the right side of the lower teeth showing the mesial attachment mechanism 15a of the push rod 12 secured to the lower archwire 19a. Note that the upper teeth are not shown in FIG. 3a; therefore, the distal attachment 15b is shown free in this figure rather than being secured to an upper archwire 19b (not shown in this illustration). FIG. 3b is an inset view illustrating a top view of a preferred embodiment of a self-ligating archwire attachment mechanism, explained in more detail below.

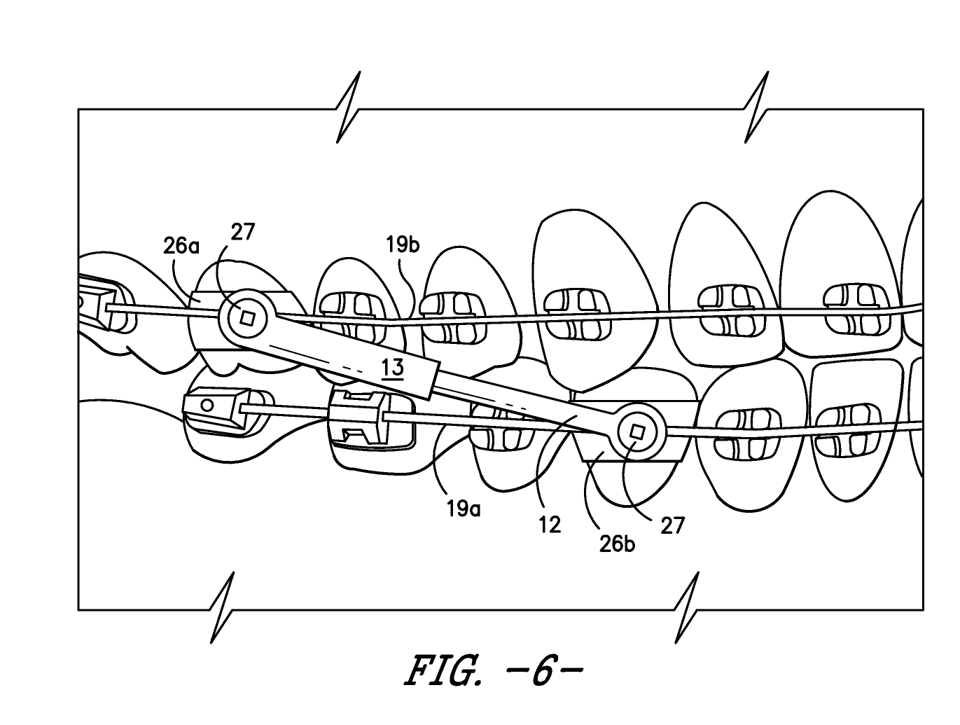

FIGS. 4 and 5 illustrate a cross-sectional side view of a preferred embodiment of the self-ligating archwire attachment mechanism. This embodiment includes a preferably U-shaped or C-shaped archwire connector 20 that may hook around the archwire 19, as shown. The archwire 19 may abut against the curved interior of the connector 20, and a free end of the connector 20 preferably includes a ball 23 for fitting into a corresponding socket 24 present on the bite corrector apparatus 11, thus attaching the apparatus 11 to the connector 20 and, consequently, the archwire 19 (as shown in FIGS. 3b-5). One arm of the archwire connector 20 may include a cut-out portion or slot 25 wherein a corresponding ligating member 21 may be inserted (as shown in FIGS. 3b and 4), thereby closing off the curvature of the connector 20 and securing/locking the connector 20 around the archwire 19, as shown in FIG. 5. The cut-out portion and corresponding ligating member may be any desired shape such as a “T”, a polygon, or any other suitable shape. In a preferred embodiment, the cut-out portion 25 of the archwire connector 20 may be T-shaped whereby a similarly T-shaped ligating member 21 fits inside like a lock and key (see FIG. 3b). When it is time to remove the bite corrector apparatus 11 or disconnect the apparatus 11 from the archwire 19, it is contemplated that the archwire connector 20 may include a notch or indentation 22 wherein a small tool, such as a flat-head screwdriver or similar leveraging deligating tool, may be inserted in the notch 22, below the ligating member 21, to deligate or open the member 21, thereby allowing the connector 20 to be unhooked from the archwire 19. FIGS. 4 and 5 show this notch 22 preferably located on an arm of the connector 20, opposite the insertion slot 25 for the ligating member.

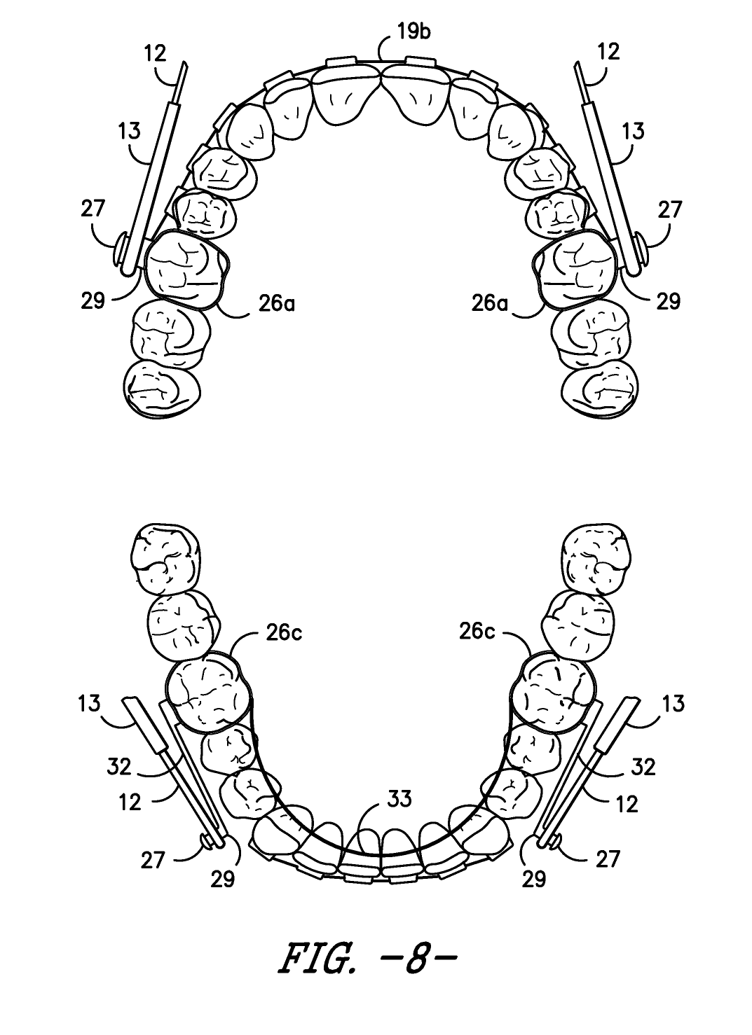

FIGS. 6-8 illustrate an exemplary arrangement of the present invention for attachment to an orthodontic band 26. This arrangement preferably utilizes a fastener attachment mechanism in lieu of an archwire attachment to facilitate movement of the jaw in addition to the teeth. In this embodiment, a fastener 27 such as a screw, rivet, or the like, may be used to secure the appliance 11 to an orthodontic band 26. Increased jaw movement and skeletal correction may be accomplished this way due to the fact that the appliance is secured directly to the teeth rather than being secured to the wire between brackets on the teeth. FIG. 7 illustrates an exploded view of a preferred embodiment where a modified screw 27 may be inserted through a hole 28 present on the distal and/or mesial end of the bite corrector 11, then inserted into a threaded receptacle 29 present on the orthodontic band 26. One embodiment illustrated by FIG. 7 shows a threaded receptacle 29 on the band 26 being preferably threaded and soldered on to the band 26, forming a slight protrusion. Preferably, the fastener 27 is an “applecore” type of screw where the outer radius 30 of the barrel is threaded similar to a typical screw, but the inner radius 31 of the barrel, which is where the distal end of the bite corrector is positioned during use, is smooth and curved to allow for unlimited lateral movement of the bite corrector 11 as well as reducing the amount of force placed on the corrective appliance 11. The bite corrector 11 may sit on the smooth, curved portion of the fastener 27, while the threaded portion of the fastener 27 may be threaded into the threaded receptacle 29 present on the band 26.

FIG. 6 shows a side view of one possible orthopedic arrangement, whereby a fastener 27 is used to secure the bite corrector 11 to a maxillary molar band 26a and a mandibular bicuspid band 26b. In another embodiment illustrated by FIG. 8, the distal portion of the spring housing 13 may be secured to a maxillary molar band 26a, while the mesial portion of the push rod 12 may be secured to a mandibular molar band 26c rather than a bicuspid band 26b as shown in FIG. 6. When secured to a mandibular molar band 26c, a cantilevered extension bar 32 may extend from the lower (mandibular) molar band 26c along the outer length of the mandibular archwire 19a, terminating near the premolars. This extension bar 32 is preferably stainless steel and of a strength and thickness capable of supporting the spring forces exerted by the bite corrector 11. Rather than the fastener 27 being secured into a threaded receptacle 29 present directly on the lower molar band 26c, the threaded receptacle 29 may be present at the terminating end of the extension bar 32 instead, thus positioning the corrector 11 at a proper operable angle. In this same arrangement, a lower lingual holding arch 33 may extend concurrently from the right mandibular molar band 26c, running along the inner length of the teeth to the left mandibular molar band 26c. This lingual holding arch 33 maintains proper position of the molars and prevents unwanted tipping of the molars by the correction device 11. It may be preferable to install an optional maxillary expansion appliance that may be soldered to the maxillary first molar bands 26a to provide palatal expansion during concomitant Class III correction.

In addition to the above-described methods of attachment, it is contemplated that the bite corrector 11 may also be connected to alternative types of fasteners such as a temporary anchorage device (TAD) to produce a more skeletal effect. TADs are commonly used temporary implants that function as an anchor. In this case, the fastener, or TAD, would secure the appropriate portion of the bit corrector 11 directly to the bone, rather than to a threaded receptacle. Anchorage devices such as TADs are common in the field of orthodontics, and any person skilled in the art would have knowledge of how to install and use these temporary anchorage devices. In the present invention, TADs could be placed on the buccal aspect of the bone, preferably one mesial to the maxillary first molar on each side and one distal to the mandibular canine on each side, for a total of four TADs. In another arrangement, two TADs could be used. The device 11 could be connected to TADs on the maxilla and attached to teeth on the mandible to provide mostly mandibular tooth movement; alternatively, the device could be connected to TADs on the mandible and attach to teeth on the maxilla to provide more maxillary tooth movement.

Once the bite corrector has been installed in the desired manner and position, the natural opening and closing of the mouth facilitates activation of the spring 14 and correction of the bite. When the mouth is closed, ideally the spring 14 and push rod 12 are positioned such that there is room in the housing 13 for both spring expansion and spring compression. This positioning is best illustrated by FIG. 2. As the mouth opens, the rod 12 will be pulled in an outward direction from the housing 13, simultaneously compressing the spring 14. As the mouth closes, the spring 14 will rebound, pulling the rod 12 inward back into the housing 13, resulting in expansion of the spring 14. It is a natural tendency of a coiled spring 14 to want to expand and resist compression, similarly to an automotive shock absorber. This expansion pulls the rod 12 further inside the housing 13, thus moving or pulling the mandibular teeth back, while simultaneously moving or pulling the maxillary teeth (and in some cases the upper jaw) forward to correct the alignment of the teeth (see directional arrows in FIG. 2). The treatment time required for correction may vary based on the severity of the malocclusion. To obtain the necessary and desired tooth movement, the appliance may need to be worn anywhere from 2 or 3 months to 6 months, although shorter or longer time periods are contemplated, as necessary. Indeed, in order to obtain the necessary and desired skeletal movement, the device may need to be worn for up to a year or more.

For the best correction result, it is desirable to maintain optimal spring resistance. It is also contemplated that in some cases the extent of the bite correction may reach a point where the spring 14 is fully expanded and in its “resting state”, yet the teeth are still not fully aligned. As previously stated, during the correction process the rod 12 is pulled inward as the spring 14 expands, thus moving the lower teeth back and bringing the upper teeth forward. When the teeth or jaw have been moved to a point where the spring housing 13 no longer has room to accommodate any further inward pulling of the rod 12, the spring 14 may need to be reactivated. Spring reactivation may be accomplished several ways depending on the amount of spring resistance needed. The upper archwire attachment mechanism 15 may be moved distal to its present location, the lower archwire attachment mechanism 15 may be moved mesial to its present location, or both the upper and lower attachment mechanisms 15 may be moved accordingly. For example, if the mesial attachment mechanism 15 is secured on the archwire 19 behind the lower canine bracket, it may be moved and secured on the archwire 19 in front of the lower canine bracket, thus pulling the rod outward from the housing, compressing the spring 14, and lengthening the appliance. Alternatively, a stop of varying millimeter lengths may be crimped onto the archwire 19 to slightly increase the distance of the correction device from its previous attachment location. These methods, in turn, “reset” the bite corrector 11 and allow it to resume its intended function.

Although the bite corrector 11 of the present invention has been described herein in terms of correcting a Class III malocclusion, it should be noted that this bite corrector 11 is also designed to correct a Class II malocclusion, also known as an overbite. The assemblies described herein may remain the same, while the appliance 11 itself may be installed in a reverse arrangement. For example, in a Class II embodiment, the distal attachment of the spring housing 13 may become a mesial or anterior attachment, and the mesial attachment of the push rod 12 may become a distal or posterior attachment. For instance, the spring housing 13 may be secured to the maxillary archwire 19a in a mesial/forward position near the upper canine, whereas the push rod 12 may be secured to the mandibular archwire 19b in a distal/back position near the lower molars. Alternatively, the push rod 12 may be secured distally to a lower orthodontic band 26 (preferably molar) via a fastener 27; whereas the spring housing 13 may be secured mesially to an upper orthodontic band 26 such as a bicuspid band, or a molar band with an extension wire (similar to the lower extension bar 32 described in FIG. 8) running the outer length of the maxillary archwire 19b and terminating at or near the upper premolars. In the latter arrangement, a transpalatal arch (similar to the lower lingual holding arch 33 shown in FIG. 8) may be used to maintain the position of the upper molars as needed.

As the present device allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

What is claimed is:

1. An orthodontic bite corrector comprising:
a housing including a first mechanism of attachment;
a rod including a second mechanism of attachment, and whereby one end of said rod is telescopically inserted into said housing;
a spring enclosed in said housing and longitudinally disposed about a portion of said rod inserted into said housing, whereby said spring and said rod move longitudinally within said housing; and
wherein said spring is compressed when said orthodontic bite corrector is in an expanded condition, and said spring is expanded when said orthodontic bite corrector is in a compressed condition.

2. The orthodontic bite corrector of claim 1, whereby corrective forces are primarily supplied through expansion of a coiled spring.

3. The orthodontic corrector of claim 1, whereby said first mechanism of attachment is adapted to mount on an existing archwire.

4. The orthodontic corrector of claim 1, whereby said second mechanism of attachment is adapted to mount on an existing archwire.

5. The orthodontic corrector of claim 3, wherein said first mechanism of attachment comprises a ligating member and a U-shaped archwire connector for attachment to said archwire, said archwire connector having a first arm and second arm, said first arm including a slot for receiving said ligating member.

6. The orthodontic corrector of claim 4, wherein said second mechanism of attachment comprises a ligating member and a U-shaped archwire connector for attachment to said archwire, said archwire connector having a first arm and second arm, said first arm including a slot for receiving said ligating member.

7. The orthodontic corrector of claim 5 or 6, wherein said slot and said ligating member include complementary T-shaped cross sections.

8. The orthodontic corrector of claim 1, whereby said first mechanism of attachment is adapted to mount on an existing orthodontic band.

9. The orthodontic corrector of claim 1, whereby said second mechanism of attachment is adapted to mount on an existing orthodontic band.

10. The orthodontic corrector of claim 8, wherein said first mechanism of attachment comprises a fastener, a hole disposed in said housing for receiving said fastener, and a threaded receptacle disposed on a said orthodontic band for receiving said fastener, whereby said fastener is inserted through said hole and into said threaded receptacle, securing said housing to said orthodontic band.

11. The orthodontic corrector of claim 9, wherein said second mechanism of attachment comprises a fastener, a hole disposed in said rod for receiving said fastener, and a threaded receptacle disposed on a said orthodontic band for receiving said fastener, whereby said fastener is inserted through said hole and into said threaded receptacle, securing said rod to said orthodontic band.

12. The orthodontic corrector of claim 10 or 11, wherein said fastener is a screw comprising a shank having a smooth inner radius and a threaded outer radius.

13. The orthodontic corrector of claim 1, whereby said first mechanism of attachment comprises a housing defining a hole adapted for receiving a fastener, whereby said fastener is inserted through said hole.

14. The orthodontic corrector of claim 1, whereby said second mechanism of attachment comprises a housing defining a hole adapted for receiving a fastener, whereby said fastener is inserted through said hole.

15. An orthodontic bite corrector comprising:
a housing having a first and second end, said first end including a first mechanism of attachment;
a rod having a first and second end, whereby said first end of said rod is lengthwise inserted into the second end of said housing, said second end of the rod including a second mechanism of attachment;
a spring longitudinally disposed around the first end of said rod and enclosed in said housing, whereby said spring and said rod move longitudinally within said housing;
wherein said spring is compressed when said orthodontic bite corrector is in an expanded condition, and said spring is expanded when said orthodontic bite corrector is in a compressed condition; and
whereby corrective forces are primarily supplied through expansion of a coiled spring.

16. The orthodontic corrector of claim 15, wherein said first and second mechanism of attachment comprises a locking fastener.

17. The orthodontic corrector of claim 16, whereby said locking fastener is adapted to mount on an archwire.

18. The orthodontic corrector of claim 16, whereby said locking fastener is adapted to mount on an orthodontic band.

19. A method of correcting a Class III malocclusion comprising the steps of:
providing a housing having a first and second end, said first end including a mechanism of attachment to a maxillary archwire;
providing a rod having a first and second end, whereby said first end of said rod is lengthwise inserted into the second end of said housing, said second end of the rod including a mechanism of attachment to a mandibular archwire;
providing a spring disposed about the first end of said rod and enclosed in said housing, whereby said spring and said rod move longitudinally within said housing;
attaching said housing distally to said maxillary archwire;
attaching said rod mesially to said mandibular archwire;
activating said spring by compressing said spring during mouth opening and expanding said spring during mouth closure; and
supplying corrective forces primarily through expansion of said coiled spring.

20. A method of correcting a Class III malocclusion comprising the steps of:
providing a housing having a first and second end, said first end including a mechanism of attachment to a maxillary molar band;
providing a rod having a first and second end, whereby said first end of said rod is lengthwise inserted into the second end of said housing, said second end of the rod including a mechanism of attachment to a mandibular molar band;
providing a spring disposed about the first end of said rod and enclosed in said housing, whereby said spring and said rod move longitudinally within said housing;
attaching said housing distally to said maxillary molar band;
attaching said rod mesially to said mandibular molar band;
activating said spring by compressing said spring during mouth opening and expanding said spring during mouth closure; and
supplying the majority of corrective forces through expansion of said coiled spring.

21. A method of correcting a Class II malocclusion comprising the steps of:
providing a housing having a first and second end, said first end including a mechanism of attachment to a maxillary archwire;
providing a rod having a first and second end, whereby said first end of said rod is lengthwise inserted into the second end of said housing, said second end of the rod including a mechanism of attachment to a mandibular archwire;
providing a spring disposed about the first end of said rod and enclosed in said housing, whereby said spring and said rod move longitudinally within said housing;
attaching said housing mesially to said maxillary archwire;
attaching said rod distally to said mandibular archwire;
activating said spring by compressing said spring during mouth opening and expanding said spring during mouth closure; and
supplying the majority of corrective forces through expansion of said coiled spring.

22. A method of correcting a Class II malocclusion comprising the steps of:
providing a housing having a first and second end, said first end including a mechanism of attachment to a maxillary molar band;
providing a rod having a first and second end, whereby said first end of said rod is lengthwise inserted into the second end of said housing, said second end of the rod including a mechanism of attachment to a mandibular molar band;
providing a spring disposed about the first end of said rod and enclosed in said housing, whereby said spring and said rod move longitudinally within said housing;
attaching said housing mesially to said maxillary molar band;
attaching said rod distally to said mandibular molar band;
activating said spring by compressing said spring during mouth opening and expanding said spring during mouth closure; and
supplying the majority of corrective forces through expansion of said coiled spring.

23. A method of correcting a Class III malocclusion comprising the steps of:
providing a housing having a first mechanism of attachment;
providing a rod having a second mechanism of attachment, and whereby one end of said rod is telescopically inserted into said housing;
providing a spring disposed about the first end of said rod and enclosed in said housing, whereby said spring and said rod move longitudinally within said housing;
activating said spring by compressing said spring during mouth opening and expanding said spring during mouth closure; and
supplying corrective forces primarily through expansion of said coiled spring.

24. A method of correcting a Class II malocclusion comprising the steps of:
providing a housing having a first mechanism of attachment;
providing a rod having a second mechanism of attachment, and whereby one end of said rod is telescopically inserted into said housing;
providing a spring disposed about the first end of said rod and enclosed in said housing, whereby said spring and said rod move longitudinally within said housing;
activating said spring by compressing said spring during mouth opening and expanding said spring during mouth closure; and
supplying corrective forces primarily through expansion of said coiled spring.
